(19) United States
(12) Patent Application Publication
(10) Pub. No.: US 2010/0150475 A1
(43) Pub. Date: Jun. 17, 2010

(54) UP-SCALING IMAGES USING INTERPOLATING FUNCTION

(75) Inventor: David Eugene Holland, Granada Hills, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: ASCENT MEDIA GROUP, INC., Santa Monica, CA (US)

(21) Appl. No.: 12/337,552

(22) Filed: Dec. 17, 2008

(51) Int. Cl. G06K 9/32

(52) U.S. Cl. 382/300

(57) ABSTRACT

An embodiment is a method and apparatus to provide a technique to scale up an image. A first image at a first size is expanded to a second size in first and second dimensions. The second size is larger than the first size and includes the first size and interpolating positions. The expanded image is convolved with a two-dimensional finite-impulse response (FIR) filter having coefficients determined by a two-dimensional interpolating function to generate interpolated pixels at the interpolating positions. The interpolated pixels are part of an up-scaled image at the second size.

### TECHNICAL FIELD

The presently disclosed embodiments are directed to the field of multimedia, and more specifically, to image processing.

### BACKGROUND

Digital image processing has become popular in multimedia, motion pictures, digital intermediates, and film recording. Typically, images are digitized for digital processing such as image restoration, enhancement, color adjustment, and special effects rendering. A film recorder is a device that records the digitized image on photographic films. It is often desirable to up-scale the image from one resolution (e.g., 2K) to a higher resolution (e.g., 4K) before recording to films to improve the sharpness of the images.

There are a number of techniques to up-scale images. The nearest neighbor technique selects the nearest neighbor of a pixel as the interpolated value. This technique is simple to implement and does not require a lot of computations; but the interpolated values do not reflect the accurate values and the resulting image tends to exhibit frequency aliasing where the higher frequencies fold back down and appear as lower frequencies. The bicubic interpolation technique applies a two-dimensional low-degree polynomial, called a spline function to the image. This technique provides a smoother interpolation; but there may still be discontinuities at the second derivatives and it is difficult to select a proper spline function.

### SUMMARY

One disclosed feature of the embodiments is a method and apparatus to provide a technique to scale up an image. A first image at a first size is expanded to a second size in first and second dimensions. The second size is larger than the first size and includes the first size and interpolating positions. The expanded image is convolved with a two-dimensional finite-impulse response (FIR) filter having coefficients determined by a two-dimensional interpolating function to generate interpolated pixels at the interpolating positions. The interpolated pixels are part of an up-scaled image at the second size.

### BRIEF DESCRIPTION OF THE DRAWINGS

Embodiments may best be understood by referring to the following description and accompanying drawings that are used to illustrate embodiments of the invention. In the drawings.

FIG. 1 is a diagram illustrating a system according to one embodiment.

FIG. 2 is a diagram illustrating expanding and re-sampling an image according to one embodiment.

FIG. 3 is a diagram illustrating a row-wise convolution of the expanded image according to one embodiment.

FIG. 4 is a diagram illustrating a column-wise convolution of the row-wise convolved image according to one embodiment.

FIG. 5 is a diagram illustrating a one-dimensional convolution with an approximated sinc function according to one embodiment.

FIG. 6 is a flowchart illustrating a process to up-scale an image according to one embodiment.

FIG. 7 is a flowchart illustrating a process to expand an image according to one embodiment.

FIG. 8 is a flowchart illustrating a process to convolve the expanded image according to one embodiment.

FIG. 9 is a diagram illustrating an image scale processor according to one embodiment.

### DETAILED DESCRIPTION

One disclosed feature of the embodiments is a technique to scale up an image. A first image at a first size is expanded to a second size in first and second dimensions. The second size is larger than the first size and includes the first size and interpolating positions. The expanded image is convolved with a two-dimensional finite-impulse response (FIR) filter having coefficients determined by a two-dimensional interpolating function to generate interpolated pixels at the interpolating positions. The interpolated pixels are part of an up-scaled image at the second size.

In the following description, numerous specific details are set forth. However, it is understood that embodiments of the invention may be practiced without these specific details. In other instances, well-known circuits, structures, and techniques have not been shown to avoid obscuring the understanding of this description.

One disclosed feature of the embodiments may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc. One embodiment may be described by a schematic drawing depicting a physical structure. It is understood that the schematic drawing illustrates the basic concept and may not be scaled or depict the structure in exact proportions.

One disclosed feature of the embodiments is a technique to scale up an image by increasing its size or resolution. The technique uses an approximation of the Whittaker-Shannon interpolation formula by using an approximated sinc function. If the image data in the image are properly band-limited, then the technique may accurately interpolate the image data up to the frequencies approaching the Nyquist rate.

The image is first expanded from a first size to a second size in first and second dimensions (e.g., x and y dimensions). The second size is larger than the first size and includes the first size and interpolating positions. The first size may be M×N and the second size may be k times the first size, or k(M×N). The expanded image has zeros at interpolating positions. This may be done by creating an image array having the second size which is k times the first size in the first and second dimensions. The image array is first initialized with zeros. Then, the first image is copied to the image array such that the pixels of the first image occupy every k positions in the image array in both dimensions, leaving the zeros at the interpolating positions. The interpolating positions are the positions at which interpolated values of pixels are computed. Then, the expanded image is convolved with a two-dimensional (2-D) FIR filter having coefficients determined by a 2-D interpolating function to generate interpolated pixels at the interpolating positions. The interpolated pixels and the first image form an up-scaled image at the second size. The 2-D interpolating function is separable into a first one-dimensional (1-D) interpolating function in the first dimension and a second 1-D interpolating function in the second dimension. Since the 2-D FIR filter is separable, the 2-D convolution may also be separable. In other words, the 2-D convolution may be performed by a 1-D convolution in one dimension followed by a 1-D convolution in the other dimension. Specifically, the expanded image is convolved with the first 1-D interpolating function in the first dimension to produce a first convolved image. Then, the first convolved image is convolved with the second 1-D interpolating function in the second dimension to produce the interpolated pixels. The interpolating function may be any function that is suitable for interpolation. In one embodiment, this 2-D function is separable. One example of such function is the sinc( ) function.

After the interpolated pixels are computed to form the up-scaled image, the up-scaled image may be transferred to a film recorder to be recorded on to films. In one embodiment, the transfer of the scaled image may be initiated manually. In another embodiment, if the film recorder has a wired or wireless interface to the processing system, the transfer may be performed by a processing unit either in the processing system or in the film recorder.

The technique may be used to up-scale a down-scaled image. In this application, an image may be down-scaled or re-sampled from a third size to the first size. The image at the first size may be processed using digital image techniques for any suitable purposes such as digital image restoration, enhancement, color adjustment, etc. After the image is processed, it may then be up-scaled to higher resolution or larger size as discussed above.

It is noted that the term “size” here is used to indicate the resolution, or the number of pixels contained in the image in each dimension. For example, the first size may be 2K×2K and the second size may be 4K×4K. As another example, the first size may be 2048×1556 and the second size may be 4096×3112. In general the first size may be organized as M×N where N refers to the number of rows and M refers to the number of columns. The second size is k times the first size, or kM×kN=k(M×N). The technique may also be extended to the second size with two different scale factors in the two dimensions. For example, the second size may be k₂M×k₁N where k₁≠k₂.

The result is that the up-scaled image has more accurate interpolated values than those computed using existing techniques such as nearest neighbor or bi-cubic interpolation.

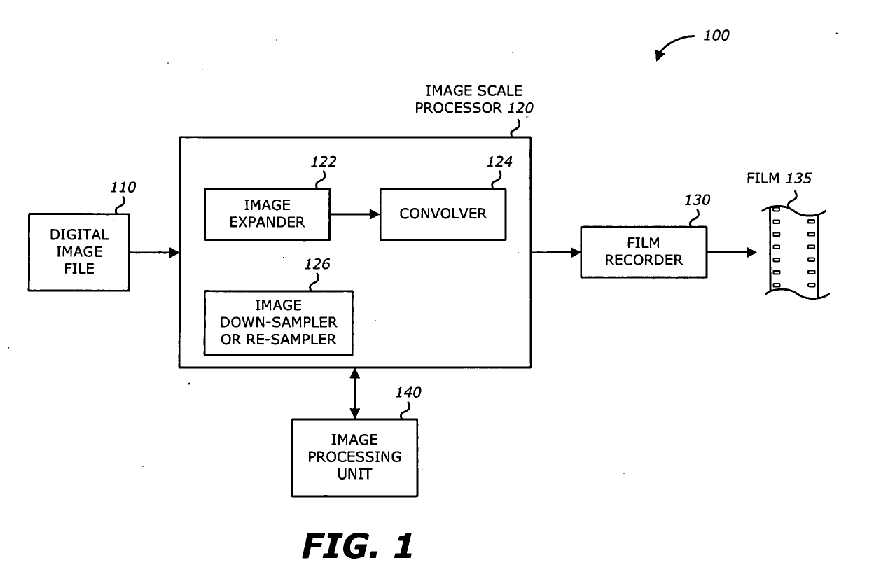

FIG. 1 is a diagram illustrating a system 100 according to one embodiment. The system 100 includes a digital image file 110, an image scale processor 120, a film recorder 130, and an image processing unit 140. The system 100 may include more or less than the above components.

The digital image file 110 contains digital images that are to be processed or scaled. The scaling may be up-scaling or down-scaling. Scaling is an operation that changes the size or resolution of an image. Up-scaling increases the size or resolution of an image while down-scaling decreases its size or resolution.

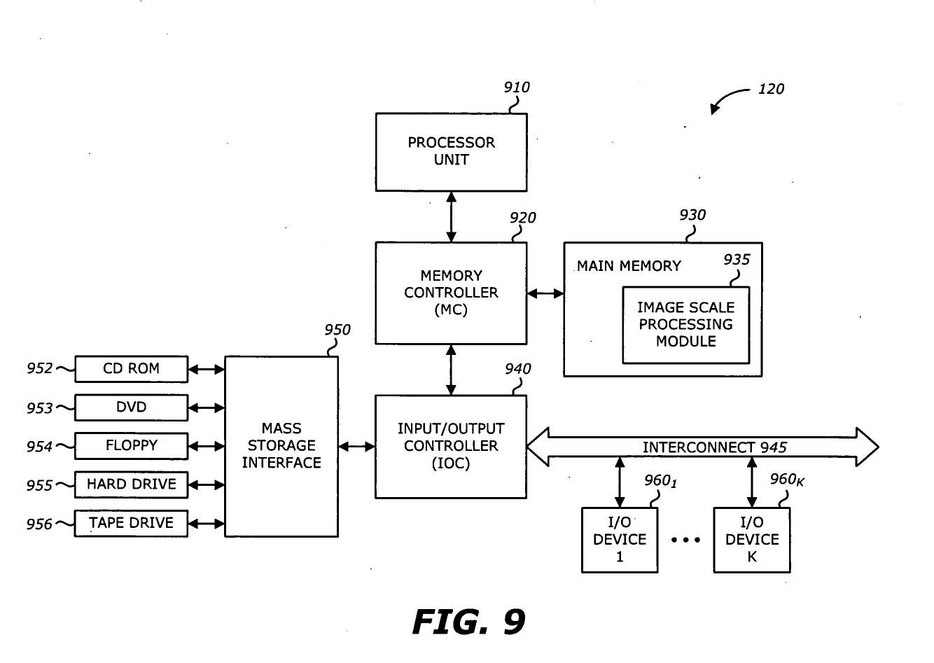

The image scale processor 120 is a processing unit that performs the scaling operation on the images from the digital image file 110. The image scale processor 120 may be a hardware unit, a software module, a firmware module, or any combination of hardware, software, and firmware. As a hardware unit, it may be a processor with special circuits to perform dedicated functions as described below. As a software module, it may include a programmable system as described in FIG. 9. As a firmware module, it may contain firmware instructions to perform scale operations as described in the following.

The image scale processor 120 includes an image expander 122, a convolver 124, and an image re-sampler 126. The image expander 120 expands an image at a first size to a second size. The expanding operation is described below. The convolver 124 performs a 2-D convolution on the expanded image with a 2-D FIR filter whose coefficients are determined by a 2-D approximated sinc function. As discussed below, the 2-D convolution may be performed by two 1-D convolutions, one for each dimension. The convolver 124 may include a first 1-D convolver for the first dimension and a second 1-D convolver for the second dimension. The image re-sampler 126 re-samples or down-scales an image as described below.

The film recorder 130 is a unit or system that writes, records, or transfers the digital images to a photographic film 135. The film recorder 130 may record films with a beam of light from a cathode ray tube, a light valve technology, or a laser unit. It may also be an electron beam recorder (EBR). The film 135 may be any film with any suitable format such as 35 mm negative film or transparencies.

The image processing unit 140 may be any unit that performs image processing on the images that are down-scaled or up-scaled by the image scale processor 120. The imaging operations may include any suitable operations for a targeted application. Examples of these operations may include digital image restoration, image enhancement, sharpening, digital intermediate operations, color adjustment, etc.

One embodiment includes a technique to up-scale an image. This operation may be performed by the image scale processor 120. The input to the image scale processor 120 may be an image having a size of M×N, i.e., M columns and N rows. Up-scaling an image includes expanding the image and convolving the image with an approximated sinc function or an interpolating function.

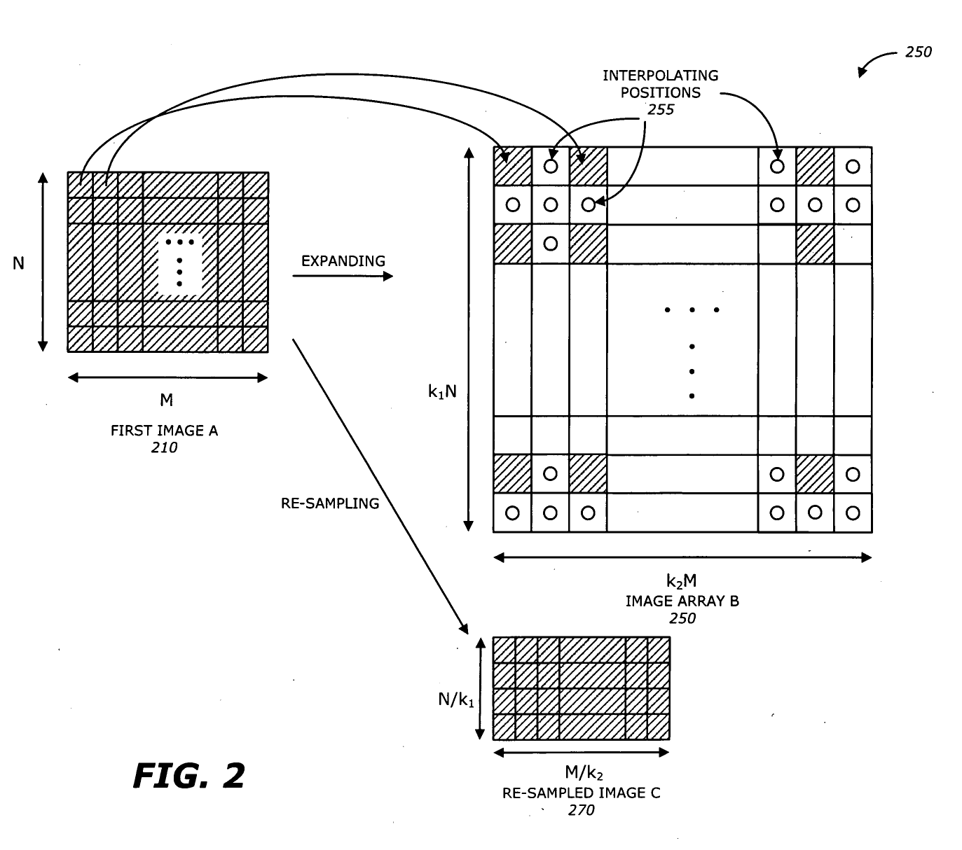

FIG. 2 is a diagram illustrating expanding and down-sampling/ re-sampling an image according to one embodiment. The image expanding may be performed by the image expander 122 in the image scale processor 120 shown in FIG. 1. The image down-sampling, or re-sampling, may be performed by the down-sampler/ re-sampler 126 in the image scale processor 120. The input image is a first image A 210 having a size of M×N. The size may be any suitable size. In one embodiment, it may be compatible with the standard sizes accepted by the film recorder 130. For example, it may be 2048×1556, denoted as 2K, or 4096×3112, denoted as 4K. The expanded image B 250 has a size of k₂M×k₁N. The down-sampled image C 270 has a size of M/k₂×N/k₁. The expanded image B 250 is used in a first phase of the up-scaling operation.

The first image A 210 is expanded into an image array B 250 having a second size, or second resolution. The second size is larger than the first size by factors in first and second dimensions (e.g., x and y dimensions). The scale factors may be the same or different. The second size is k₂M×k₁N. In one embodiment, k₁=k₂=k.

The image array B 250 may be first initialized with zeros. It is noted that it is not necessary to initialize with zeros because the original pixels will occupy the appropriate positions and the positions that are not occupied by the original pixels are the interpolating positions whose values will be computed by the convolution described in the following. Then, the first image A 210 is copied to the image array B 250 such that pixels in the first image occupy every k₁ positions in row and k₂ positions in column. In FIG. 2, k₁=k₂=2. For down-scaling or re-sampling, the reverse operation may be performed. In other words, the first image A 210 is first filtered with an appropriate low-pass filter to prevent aliasing and is then copied to the image C, skipping every k₁ pixels on the first dimension and every k₂ pixels on the second dimension.

The operations may be described by the following pseudo-code. In the following pseudo code, it is assumed that the indexing of the image starts at an index equal to 1.

```
Start expanding
for i = 1 to k₁N
    for j = 1 to k₂M
        B[i][j] = 0; /* initialized the image array */
n = 1; /* initialize the A indices */
for i = 1 to k₁N; i+= k₁
    m = 1;
    for j = 1 to k₂M; j += k₂
        B[i][j] = A[n][m];
        m += 1;
    n += 1;
End expanding.
Start down-sampling or re-sampling
Perform appropriate low-pass filtering to avoid frequency aliasing;
n = 1; /* initialize the C indices */
for i = 1 to k₁N; i+= k₁
    m = 1;
    for j = 1 to k₂M; j += k₂
        C[n][m] = B[i][j];
        m += 1;
    n += 1;
End down-sampling or re-sampling
```

After the above expanding operation is completed, the unoccupied pixel positions in the image array B are left with zeros or any other values which will be replaced by the interpolated values as computed in the subsequent operations. These positions are the interpolating positions 255 which contain interpolated pixel values as computed in the convolution phase. After the above down-sampling or re-sampling operation is completed, the down-sampled image C may then be used for restoration work and then be up-scaled to the appropriate resolution.

In the convolution phase, the expanded image array B is convolved with a 2-D FIR filter whose coefficients are determined by a 2-D interpolating function. The convolution may be performed by the convolver 124 in the image scale processor 120 shown in FIG. 1. In one embodiment, the interpolating function is an approximated sinc( ) function. It is understood that other interpolating functions may be used. The 2-D sinc function may be expressed as:

sinc (x,y)=sinc (x)*sinc (y) (1)

sinc (x,y)={sin(πx)/πx}*{sin(πy)/πy} (2)

where * denotes a multiplication.

It is understood that the values of the function are computed accordingly. For example, for a 3 to 1 expansion, the sinc(x) may be used at, for example, −2⅓, −1⅓, −⅓, +⅔, +1⅔, +2⅔, etc. Then, the next interpolation value would use sinc(x) at x=−2⅔.−1⅔, −⅔, +⅓, +1⅓, +2⅓, etc. In addition, the value of sinc(x) is defined to be 1 for x=0 even though this definition is undefined for x=0 due to the division by zero problem.

The 2-D approximated sinc function is separable into a first 1-D approximated sinc function in the first dimension (e.g., x dimension) and a second 1-D approximated sinc function in the second dimension (e.g., y dimension) as shown in equation (2). A separable 2-D filter is one that has an impulse response to be a product of two 1-D impulse responses. A separable 2-D filter allows a 2-D convolution to be performed as two successive 1-D convolutions, one for each dimension. This reduces the computation burden significantly. The order of the 1-D convolutions may be arbitrary. In other words, the convolution may start with the row-wise convolution followed by a column-wise convolution, or it may start with a column-wise convolution followed by a row-wise convolution.

The 1-D convolution may be performed in the spatial domain or in the frequency domain. In the spatial domain, the convolution may be performed as a series of multiplications and summations. In the frequency domain, the convolution may be performed by the Fast Fourier Transform (FFT) by multiplying the DFT (or FFT) of the image and the DFT (or FFT) of the sinc function, i.e., performing an equivalent of convolution by a pointwise multiplication in frequency domain, as is well known in the art

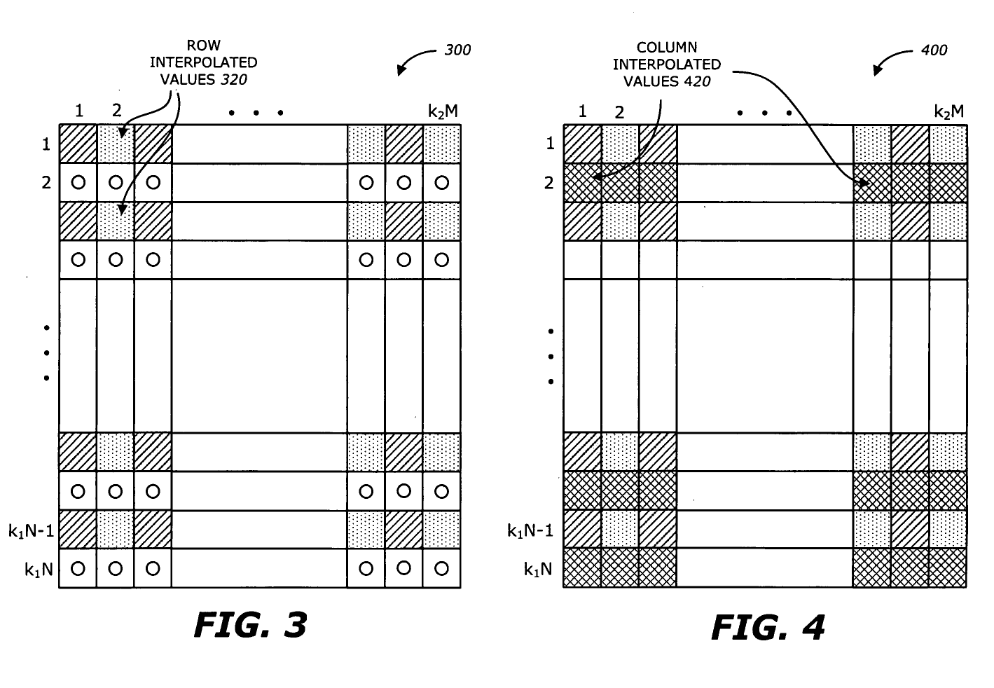

FIG. 3 is a diagram illustrating a row-wise convolution of the expanded image according to one embodiment. For illustrative purposes, zeros are shown in the interpolated positions. The 1-D convolution is performed on a row-by-row basis to produce a first convolved image 300. Each convolution produces a row interpolated value 320 at an interpolating position. Suppose the 1-D FIR filter whose coefficients are the 1-D sinc function has a length of P. Then, as typical in convolution, the pixels values at the P/2 (for P even) and (P-1)/2 pixel locations at the beginning and at the end of each row are not processed because the convolution produces the interpolated value at the center of the filter. Alternatively, the pixels at the borders may be replicated to extend the size of the image by half the filter width so that the entire image may be processed. In addition, since the convolution is used to compute the (k₂−1) interpolated values where the first values of the (k₂−1) interpolated values are located at every k₂ pixels, the convolution is performed at every k₂ pixels for (k₂−1) times consecutively. For each batch of (k₂−1) interpolated values, the filter is shifted one position until all (k₂−1) interpolated values have been computed. In other words, after (k₂−1) convolutions for the (k₂−1) interpolated pixels, the filter is shifted k₂ positions from the previous starting position (or only one position if the filter has already been shifted while computing the (k₂−1) interpolated pixels) in order to compute the next (k₂−1) interpolated pixels. For example, if k₂=2, the interpolated values are located at every other pixels. There is one interpolated value between two original adjacent pixels. The convolution is performed once, and the filter is then shifted two positions to compute the next interpolated value. If k₂=3, there are two interpolated values between two original adjacent pixels. The convolution is performed two times, one for each of the interpolated value.

Furthermore, since the expanded image contains rows of zeros, or values that are irrelevant, at every k₁ rows, the row-wise 1-D convolutions may be performed on every k₁ rows, skipping rows that contain all zeros, or irrelevant data. This further reduces computational burden. The row-wise 1-D convolution process produces a first convolved image 300.

FIG. 4 is a diagram illustrating a column-wise convolution of the row-wise convolved image according to one embodiment. The column-wise convolution may be performed in a similar manner as the row-wise convolution. The 1-D convolution is performed on a column by column basis on the first convolved image 300 to produce a final result image 400. The final result image 400 is the up-scaled image with the second size of k₂M×k₁N and the interpolated values are all computed. Each convolution produces a column interpolated value 420 at an interpolating position. Suppose the 1-D FIR filter whose coefficients are the 1-D approximated sinc function has a length of P. Then, as typical in convolution, the pixels values at the P/2 (for P even) and (P-1)/2 (for P odd) pixel locations at the beginning and at the end of each column are not processed because the convolution produces the interpolated value at the center of the filter. Alternatively, the pixels at the borders may be replicated to extend the size of the image by half the filter width so that the entire image may be processed. In addition, since the convolution is used to compute the (k₁−1) interpolated values where the first values of the (k₁−1) interpolated values are located at every k₁ pixels, the convolution is performed at every k₁ pixels for (k₁−1) times consecutively. For each batch of (k₁−1) interpolated values, the filter is shifted one position until all (k₁−1) interpolated values have been computed. In other words, after (k₁−1) convolutions for the (k₁−1) interpolated values, the filter is shifted k₁ positions from the previous starting position (or only one position if the filter has already been shifted while computing the (k₁−1) interpolated pixels) in order to compute the next (k₁−1) interpolated pixels.

Unlike in the row-wise convolutions, there are no columns that contain all zeros as filled in the initialization phase. Accordingly, the column-wise 1-D convolutions are performed on every column, and not on every k₂ columns. Of course if the convolutions are performed on the columns first followed by the row-wise convolutions, then the column-wise 1-D convolutions may be performed on every k₂ columns. Then, the row-wise 1-D convolutions are performed on every row.

As mentioned above, the sinc function is approximated because the filter length is truncated. Suppose the sinc function filter has a length of P. P may be odd or even depending on the scale factors k₁ or k₂. In one embodiment, P may be even. Using a filter with even length, the interpolated value is located in the center of the window which corresponds to the missing value.

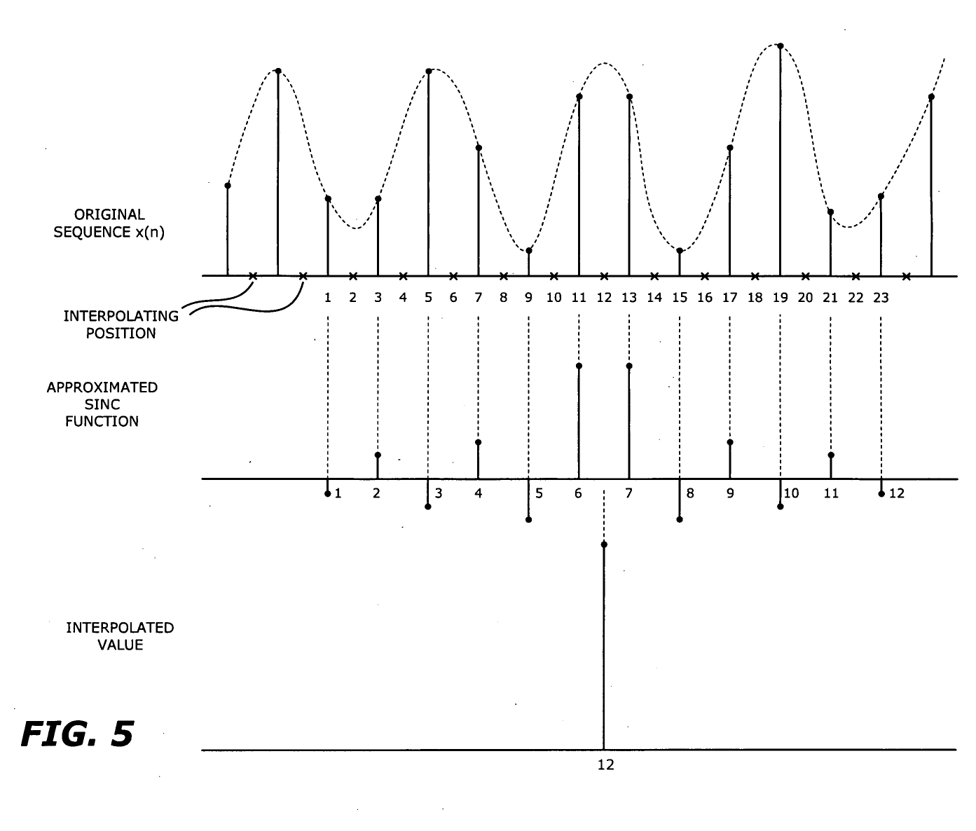

FIG. 5 is a diagram illustrating a one-dimensional convolution with an approximated sinc function according to one embodiment. The 1-D convolution is performed in the spatial domain. The illustrative example shows an original data sequence as samples of a digitized sine wave. The approximated sinc function sinc(n) is truncated and has a length of P=12 values.

The original sequence x(n) has interpolating positions at every other sample where n=2, 4, 6, 8, . . . At these interpolating positions, the sequence x(n) is zero. In other words, the sequence x(n) includes x(1), 0, x(3), 0, x(5), 0, . . . , x(kM), 0. As discussed above, it is not necessary for the sequence x(n) contains zeros at the interpolating positions because these values are replaced by the interpolated values. The 1-D convolution computes the interpolated values at these interpolating positions.

Suppose the 1-D convolution is performed in the spatial domain. Since the coefficients in the 1-D filter are symmetric, there is no need to flip the coefficients as typically done in convolution. Each 1-D convolution is performed as a series of multiplications and a summation to compute one interpolated value.

Suppose the interpolation position is at n=12.

x(12)=Σ×(n)*sinc(k−α) for n=1, 3, 5, 23, and k=1, 2, . . . , 12. (3)

where * denotes multiplication and a is a shift constant so that sinc(k−a)=1 for (k−a)=0. For this particular example, a=6.5 In other words,

x(12)=x(1)*sinc(1−6.5)+x(3)*sinc(2−6.5)+x(5)*sinc(3−6.5)+ . . . +x(23)*sinc(12−6.5) (4)

The interpolated value x(12) is computed and provides the missing value of the sequence x(n) at the interpolating position n=12. After this 1-D convolution, the sinc filter is shifted two positions and the 1-D convolution is repeated to compute the interpolated value at the interpolating position n=14. Then, the process is repeated until the entire sequence is computed.

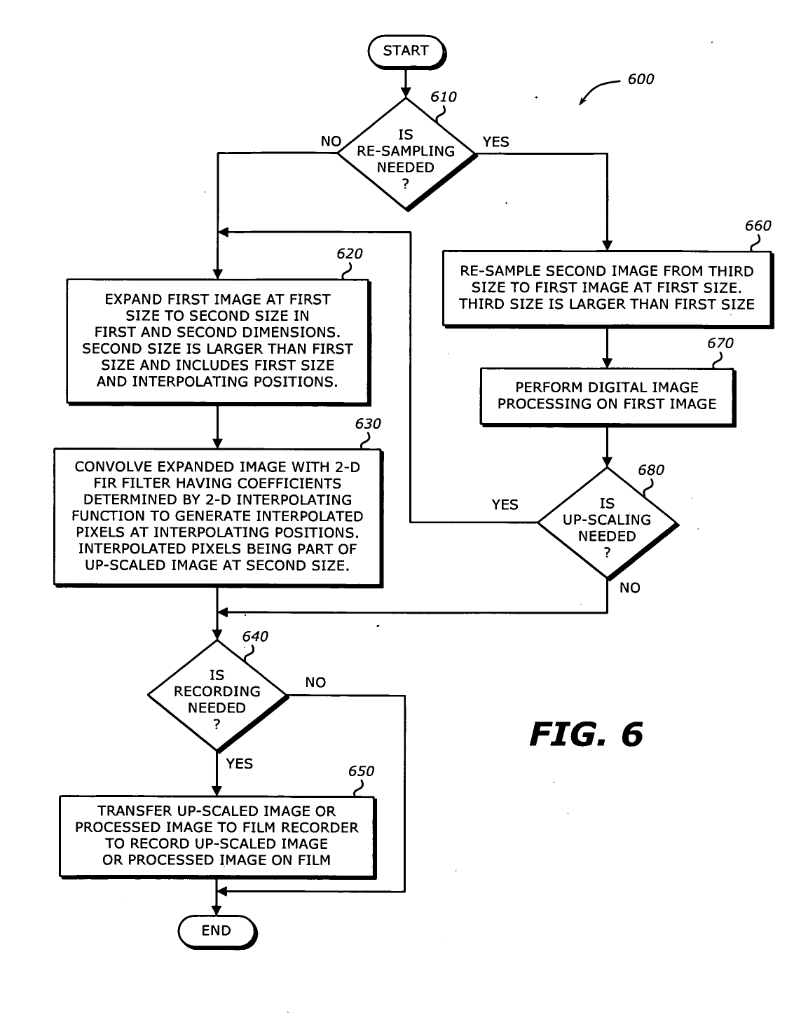

FIG. 6 is a flowchart illustrating a process 600 to up-scale an image according to one embodiment.

Upon START, the process 600 determines if down-sampling or re-sampling is needed (Block 610). A re-sampling may be needed to down-scale an image for processing before up-scaling. If it is not needed, the process 600 expands a first image at a first size to a second size in first and second dimensions (Block 620). The second size is larger than the first size and includes the first size and interpolating positions.

Then, the process 600 convolves the expanded image with a 2-D FIR filter having coefficients determined by a 2-D interpolating function to generate interpolated pixels at the interpolating positions (Block 630). The interpolated pixels are part of an up-scaled image at the second size. It is noted that if the interpolating function is such that it is necessary to re-compute the values of the original pixels, then the newly computed values will be saved in a separate output array. As discussed above, the 2-D convolution may be performed as two 1-D convolutions, one for each dimension.

Next, the process 600 determines if recording is needed (Block 640). If not, the process 600 is terminated at END. Otherwise, the process 600 transfers the up-scaled image or the processed image (as performed in Block 670) to a film recorder to record the up-scaled image or the processed image on a film (Block 650). The process 600 is then terminated at END.

At Block 610, if down-sampling or re-sampling is needed, the process 600 re-samples a second image from a third size to the first image at the first size (Block 660). The down-sampling or re-sampling may be performed by the image down-sampler/ re-sampler 126 in the image scale processor 120 shown in FIG. 1. The third size is larger than the first size. In one embodiment, the third size is equal to the second size. This re-sampling is performed prior to expanding the first image. Then, the process 600 performs digital image processing operations on the first image (Block 670). Next, the process 600 determines if up-scaling is needed (Block 680). If not, the process 600 proceeds to Block 640. Otherwise, the process 600 proceeds to Block 620 to begin up-scaling the first image.

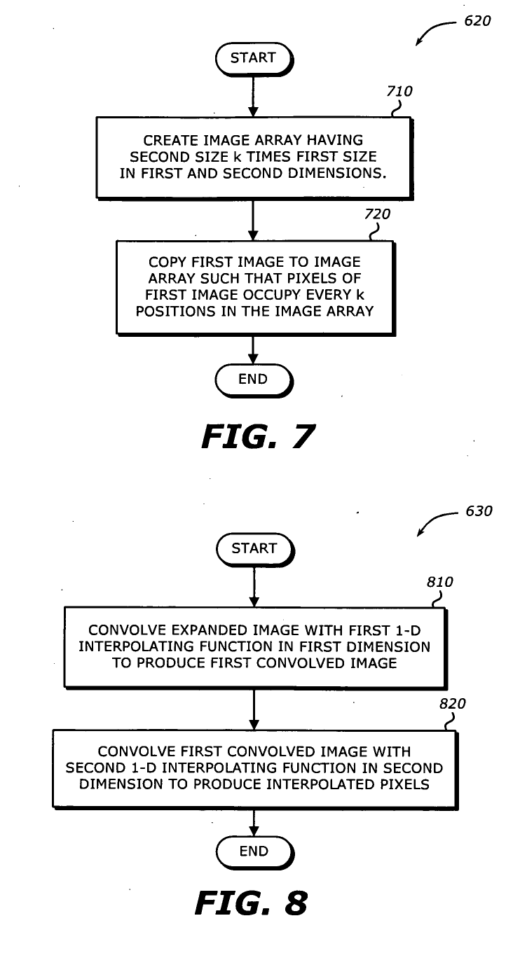

FIG. 7 is a flowchart illustrating the process 620 shown in FIG. 6 to expand an image according to one embodiment.

Upon START, the process 620 creates an image array having the second size k times the first size in the first and second dimensions (Block 710). If the scale factors are different (e.g., k₁ and k₂), the image array may be created to have the second size with k₁ times the first dimension and k₂ times the second dimension. Next, the process 620 copies the first image to the image array such that pixels of the first image occupy every k positions in the image array (Block 720). If the scale factors are different, then the pixels occupy every k₁ positions in the first dimension and every k₂ positions in the second dimension. The process 620 is then terminated.

FIG. 8 is a flowchart illustrating the process 630 to convolve the expanded image according to one embodiment.

Upon START, the process 630 convolves the expanded image with the first one-dimensional approximated interpolating function in the first dimension to produce a first convolved image (Block 810). Next, the process 630 convolves the first convolved image with the second one-dimensional approximated interpolating function in the second dimension to produce the interpolated pixels (Block 820). The process 630 is then terminated.

FIG. 9 is a diagram illustrating the image scale processor 120 shown in FIG. 1 according to one embodiment. The image scale processor 120 includes a processor unit 910, a memory controller (MC) 920, a main memory 930, an input/output controller (IOC) 940, an interconnect 945, a mass storage interface 950, and input/output (I/O) devices 960₁ to 960_{K}. The processor 120 may include more or less of the above components.

The processor unit 910 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The MC 920 provides control and configuration of memory and input/output devices such as the main memory 930 and the IOC 940. The MC 920 may be integrated into a chipset that integrates multiple functionalities such as graphics, media, host-to-peripheral bus interface, memory control, power management, etc.

The main memory 930 stores system code and data. The main memory 930 is typically implemented with dynamic random access memory (DRAM), static random access memory (SRAM), or any other types of memories including those that do not need to be refreshed. The main memory 930 may include multiple channels of memory devices such as DRAMs. The main memory 930 may contain the image scale processing module 935 that performs the functions of the image scale processor 120.

The IOC 940 has a number of functionalities that are designed to support I/O functions. The IOC 940 may also be integrated into a chipset together or separate from the MC 920 to perform I/O functions. The IOC 940 may include a number of interface and I/O functions such as peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, wireless interconnect, direct media interface (DMI), etc.

The interconnect 945 provides interface to peripheral devices. The interconnect 945 may be point-to-point or connected to multiple devices. For clarity, not all interconnects are shown. It is contemplated that the interconnect 945 may include any interconnect or bus such as Peripheral Component Interconnect (PCI), PCI Express, Universal Serial Bus (USB), Small Computer System Interface (SCSI), serial SCSI, and Direct Media Interface (DMI), etc.

The mass storage interface 950 interfaces to mass storage devices to store archive information such as code, programs, files, data, and applications. The mass storage interface may include SCSI, serial SCSI, Advanced Technology Attachment (ATA) (parallel and/or serial), Integrated Drive Electronics (IDE), enhanced IDE, ATA Packet Interface (ATAPI), etc. The mass storage device may include compact disk (CD) read-only memory (ROM) 952, digital video/versatile disc (DVD) 953, floppy drive 954, hard drive 955, tape drive 956, and any other magnetic or optic storage devices. The mass storage device provides a mechanism to read machine-accessible media.

The I/O devices 960₁ to 960_{K} may include any I/O devices to perform I/O functions. Examples of I/O devices 960₁ to 960_{K} include controller for input devices (e.g., keyboard, mouse, trackball, pointing device), media card (e.g., audio, video, graphic), and any other peripheral controllers.

Elements of one embodiment may be implemented by hardware, firmware, software or any combination thereof. The term hardware generally refers to an element having a physical structure such as electronic, electromagnetic, optical, electro-optical, mechanical, electromechanical parts, etc. A hardware implementation may include analog or digital circuits, devices, processors, applications specific integrated circuits (ASICs), programmable logic devices (PLDs), field programmable gate arrays (FPGAs), or any electronic devices. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EPROM). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations. The program or code segments may be stored in a processor or machine accessible medium. The “processor readable or accessible medium” or “machine readable or accessible medium” may include any medium that may store information. Examples of the processor readable or machine accessible medium that may store include a storage medium, an electronic circuit, a semiconductor memory device, a read only memory (ROM), a flash memory, an erasable programmable ROM (EPROM), a floppy diskette, a compact disk (CD) ROM, an optical disk, a hard disk, etc. The machine accessible medium may be embodied in an article of manufacture. The machine accessible medium may include information or data that, when accessed by a machine, cause the machine to perform the operations or actions described above. The machine accessible medium may also include program code, instruction or instructions embedded therein. The program code may include machine readable code, instruction or instructions to perform the operations or actions described above. The term “information” or “data” here refers to any type of information that is encoded for machine-readable purposes. Therefore, it may include program, code, data, file, etc.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method comprising:
expanding a first image at a first size to a second size in first and second dimensions, the second size being larger than the first size and including the first size and interpolating positions; and
convolving the expanded image with a two-dimensional finite-impulse response (FIR) filter having coefficients determined by a two-dimensional interpolating function to generate interpolated pixels at the interpolating positions, the interpolated pixels being part of an up-scaled image at the second size.

2. The method of claim 1 wherein expanding the first image comprises:
creating an image array having the second size k times the first size in the first and second dimensions; and
copying the first image to the image array such that pixels of the first image occupy every k positions in the image array.

3. The method of claim 1 wherein the two-dimensional interpolating function is separable into a first one-dimensional interpolating function in the first dimension and a second one-dimensional interpolating function in the second dimension.

4. The method of claim 3 wherein convolving comprises:
convolving the expanded image with the first one-dimensional interpolating function in the first dimension to produce a first convolved image; and
convolving the first convolved image with the second one-dimensional interpolating function in the second dimension to produce the interpolated pixels.

5. The method of claim 1 wherein convolving comprises convolving in spatial-domain or performing an equivalent of convolution by a pointwise multiplication in frequency domain.

6. The method of claim 1 further comprising:
transferring the up-scaled image to a film recorder to record the up-scaled image on a film.

7. The method of claim 1 further comprising:
re-sampling a second image from a third size to the first image at the first size prior to expanding the first image to the second size, the third size being larger than the first size; and
performing digital image processing on the first image prior to expanding the first image to the second size.

8. The method of claim 7 wherein the third size is equal to the second size.

9. An article of manufacture comprising:
a machine-accessible storage medium including information that, when accessed by a machine, causes the machine to perform operations comprising:
expanding a first image at a first size to a second size in first and second dimensions, the second size being larger than the first size and including the first size and interpolating positions; and
convolving the expanded image with a two-dimensional finite-impulse response (FIR) filter having coefficients determined by a two-dimensional interpolating function to generate interpolated pixels at the interpolating positions, the interpolated pixels being part of an up-scaled image at the second size.

10. The article of manufacture of claim 9 wherein the information causing the machine to perform expanding the first image comprises information that, when accessed by the machine, causes the machine to perform operations comprising:
creating an image array having the second size N times the first size in the first and second dimensions; and
copying the first image to the image array such that pixels of the first image occupy every N positions in the image array.

11. The article of manufacture of claim 9 wherein the two-dimensional interpolating function is separable into a first one-dimensional interpolating function in the first dimension and a second one-dimensional interpolating function in the second dimension.

12. The article of manufacture of claim 11 wherein the information causing the machine to perform convolving comprises information that, when accessed by the machine, causes the machine to perform operations comprising:
convolving the expanded image with the first one-dimensional interpolating function in the first dimension to produce a first convolved image; and
convolving the first convolved image with the second one-dimensional interpolating function in the second dimension to produce the interpolated pixels.

13. The article of manufacture of claim 9 wherein the information causing the machine to perform convolving comprises information that, when accessed by the machine, causes the machine to perform operations comprising convolving in spatial-domain or performing an equivalent of convolution by a pointwise multiplication in frequency domain.

14. The article of manufacture of claim 9 wherein the information further comprising information that, when accessed by the machine, causes the machine to perform operations:
transferring the up-scaled image to a film recorder to record the up-scaled image on a film.

15. The article of manufacture of claim 9 wherein the information further comprising information that, when accessed by the machine, causes the machine to perform operations:
re-sampling a second image from a third size to the first image at the first size prior to expanding the first image to the second size, the third size being larger than the first size; and
performing digital image processing on the first image prior to expanding the first image to the second size.

16. The article of manufacture of claim 15 wherein the third size is equal to the second size.

17. An apparatus comprising:
an image expander to expand a first image at a first size to a second size in first and second dimensions, the second size being larger than the first size and including the first size and interpolating positions, and
a convolver coupled to image expander to convolve the expanded image with a two-dimensional finite-impulse response (FIR) filter having coefficients determined by a two-dimensional interpolating function to generate interpolated pixels at the interpolating positions, the interpolated pixels being part of an up-scaled image at the second size.

18. The apparatus of claim 17 wherein image expander creates an image array having the second size k times the first size in the first and second dimensions; and copies the first image to the image array such that pixels of the first image occupy every k positions in the image array.

19. The apparatus of claim 17 wherein the two-dimensional interpolating function is separable into a first one-dimensional interpolating function in the first dimension and a second one-dimensional interpolating function in the second dimension.

20. The apparatus of claim 19 wherein the convolver comprises:
a first one-dimensional convolver to convolve the expanded image with the first one-dimensional interpolating function in the first dimension to produce a first convolved image; and
a second one-dimensional convolver to convolve the first convolved image with the second one-dimensional interpolating function in the second dimension to produce the interpolated pixels.

21. The apparatus of claim 17 wherein the convolver convolves in spatial-domain or performs an equivalent of convolution by a pointwise multiplication in frequency domain.

22. The apparatus of claim 17 wherein the image scale processor transfers the up-scaled image to the film recorder to record the up-scaled image on a film.

23. The apparatus of claim 17 further comprising:
a re-sampler to re-sample a second image from a third size to the first image at the first size, the third size being larger than the first size.

24. The apparatus of claim 23 wherein the third size is equal to the second size.
